(19) United States
(12) Patent Application Publication
(10) Pub. No.: US 2022/0244735 A1
(43) Pub. Date: Aug. 4, 2022

(54) METHOD FOR TRANSPORTATION OF MULTIPLE ARTICLES USING A MOBILE ROBOT

(71) Applicant: Advanced Intelligent Systems Inc., Burnaby (CA)

(72) Inventors: Farhang Bidram, Burnaby (CA); Amirmasoud Ghasemi Toudeshki, Burnaby (CA); Shahram Pourazadi, Burnaby (CA); Keith Chow, Burnaby (CA)

(21) Appl. No.: 17/615,226

(22) PCT Filed: May 26, 2020
(86) PCT No.: PCT/CA2020/050713

§ 371 Date: Nov. 30, 2021

Related U.S. Application Data
(60) Provisional application No. 62/854,915, filed on May 30, 2019.
(60) Provisional application No. 62/868,726, filed on Jun. 28, 2019.
(60) Provisional application No. 62/885,553, filed on Aug. 12, 2019.

(51) Int. Cl. G05D 1/02; B60P 1/00

(52) U.S. Cl. CPC G05D 1/0214; G05D 2201/0216; B60P 1/00; G05D 1/0274

(57) ABSTRACT

A method for transportation of articles using a mobile robot. The mobile robot includes a mobile base, a manipulator which rotates relative to the mobile base, a storage platform on the base, and sensors, and has a navigation system. The method comprises: detecting articles at a pick-up area using the sensors; mapping the detected articles to a global map; selecting a set of articles according to predetermined parameters; determining a sequence for picking up the set of articles; loading the set of articles onto the mobile robot using the manipulator; determining a target position and orientation for the mobile base at the drop-off area optimal for unloading articles; the mobile robot travelling to the target position and orientation via the navigation system; unloading the set of articles using the manipulator according to predetermined settings. Also disclosed is a method for relocating the operation space of such a mobile robot.

### TECHNICAL FIELD

The present disclosure relates to control, operation and navigation of an autonomous device, particularly in the context of a mobile robot transporting a plurality of articles from one location to another.

### BACKGROUND

Robotic vehicles may be configured to carry out a certain task autonomously or semi-autonomously for a variety of applications including product transportation and material handling. Autonomous mobile robotic vehicles typically have the ability to navigate and to detect objects automatically and may be used alongside human workers, thereby potentially reducing the cost and time required to complete otherwise inefficient operations such as basic labor, transportation and maintenance. Examples of commercial mobile robots with article carrying capacity include OTTO™ mobile platforms, Kuka™ mobile robots, MiR™ mobile platforms, Kiva™ warehouse robots, and Harvest AI™ agricultural robots.

U.S. Pat. No. 8,915,692, for example, describes a methodology to autonomously transport articles, one article at a time, using a mobile robot within a boundary subsystem.

Further, some autonomous vehicles can use wireless communication with a number of beacons in order to determine a position of the vehicle within a workspace. For example, U.S. Pat. No. 6,799,099 issued to Zeitler et. al. discusses a material handling system with high frequency radio location devices, where the position of a device is determined through the device communicating in Ultra Wideband (UWB) signals with a plurality of stationary beacons. In such systems, the operation space of the device is determined by the position of such stationary beacons, and the operation space of the device is restricted by the effective range of the wireless communications.

Furthermore, such systems may be used in combination with a system for determining the orientation of the vehicle such as an internal Inertial Measurement Unit (IMU) for further localization. However, IMUs experience drift, which results in increasing error over time, and as a result require periodic recalibration. It is contemplated that a method can be used to recalibrate the IMU using references such as the beacons of the localization system, for example, in order to reduce accumulated error. By taking advantage of the localization system's innate architecture, this advantage may be achieved without the need for additional hardware or components.

The current invention discloses novel methodologies to facilitate transporting articles, multiple articles at a time, using a mobile robot.

### SUMMARY

In accordance with one disclosed aspect, a method for transportation of articles using a mobile robot is provided. The mobile robot generally includes a mobile base, a manipulator which rotates with respect to the mobile base, a storage platform disposed on the base and one or more sensors, and mobile robot is provided with a navigation system. The method includes a detecting step, a mapping step, a selecting step, a first determining step, a loading step, a first travelling step, a second determining step, an orienting step, an unloading step, and a second travelling step. The detecting step involves detecting, by one or more sensors, a plurality of articles to be transported at a predetermined pick-up area. The mapping step involves mapping, by a processing unit, the detected plurality of articles onto a global map based on an absolute coordinate system and storing the global map in a memory of the processing unit. The selecting step involves selecting, by the processing unit, a selected set of articles out of the detected plurality of articles according to predetermined parameters. In the first determining step, the processing unit determines a determined sequence for picking up the selected set of articles. In the loading step, the manipulator of the mobile robot loads the selected set of articles onto the mobile robot according to the determined sequence. The first travelling step involves the mobile robot travelling from the pick-up area to a predetermined drop-off area according to the navigation system, followed by the second determining step in which the processing unit determines a target position within the drop-off area. After the second determining step, the mobile base orients in a direction which does not require the base to be re-oriented for unloading at least two consecutive articles of the selected set of articles in the orienting step. Finally, in the second travelling step, the mobile robot travels from the drop-off area back to the pick-up area. The method may then repeat from the detecting step until all articles are transported. In certain embodiments, the processing unit may comprise a local server or cloud server, which is disposed external to the mobile robot.

The selecting step may include determining, by the processing unit, a best article to select according to the predetermined parameters. The predetermined parameters may include distance from an object, and/or obstacles detected near the object. The selecting step may also include determining, by the processing unit, a ranking of the detected plurality of articles. The first determining step may include following the determined ranking of articles. The first determining step may also include basing the determination at least in part on the global map generated in the mapping step.

The second determining step may include determining the target position based on: a relative position of the robot with respect to an object detected by the one or more sensors, an absolute position based on the absolute coordinate localization system, or any combination of the two. The predetermined settings may include a drop-off pattern, drop-off spacing, physical dimensions of the drop-off area, physical dimensions of the articles and physical dimensions of the defined operating area.

In this case, the unloading step may further include a calculating step, an aligning step, and placing step, and a switching step. In the calculating step, the processing unit calculates the number of articles which may be placed in a row at the drop-off area based off the settings. In the aligning step, the mobile robot orients itself parallel to the row. In the placing step, articles are placed into the row. In the switching step, the processing unit causes the robot to switch to a new row when the maximum number of articles in a row is detected. In this unloading step, there may also be the steps of moving, by the mobile robot, in a direction parallel to the row to control spacing between articles of the same row and adjusting, by the mobile robot, the angular orientation of a manipulator with respect to the heading of the mobile robot to control spacing of articles between different rows.

Alternatively, the unloading step may include determining, by the processing unit, an optimal unloading position and orientation, and a number of articles to be unloaded based on information from the one or more sensors, moving, by the mobile robot, to achieve the position and orientation, unloading articles around the position according to a predetermined pattern, and repeating from the determining step when the number of articles has been unloaded. In either case, the method may also further include avoiding, by the mobile robot, articles mapped in the global map during the loading, travelling, and unloading steps.

In accordance with another aspect, the unloading step may include determining, by the processing unit, in a determining step, an optimal unloading position and orientation for the mobile robot and a number of articles to be unloaded, based on the predetermined settings; moving the mobile robot to achieve the optimal unloading position and orientation; unloading articles around the optimal unloading position and orientation; and repeating from the determining step when the number of articles to be unloaded has been unloaded. In the determining step, the optimal unloading position and orientation for the mobile robot may be determined so as to avoid the mobile robot going outside of a defined operating area.

In accordance with another aspect, also disclosed herein is a method for expanding an operation space of a mobile robot. This method includes determining, by a processing unit, that the mobile robot has completed a work task in the operation space followed by assigning, by the processing unit, a relocation task to the mobile robot, the relocation task comprising moving one or more beacons of a plurality of beacons from a first position of each of the one of more beacons to a second position of each of the one or more beacons. The method then includes executing, by the mobile robot, the relocation task, the task involving navigating, by the mobile robot, to a first beacon of the one or more beacons located at a first position using a localization system comprising the plurality of beacons, interacting, by the mobile robot, with the first beacon to ready the first beacon for transport, transporting, by the mobile robot, the first beacon to a second position for the beacon, comprising navigating using the localization system, and repeating from the navigating step for each other beacon of the one or more beacons to be moved. The method then includes assigning, by the processing unit, a new work task to the mobile robot in the operation space defined by new beacon positions. In this manner, once the work task (e.g. a method of transportation of articles) has been completed for one operation space, the mobile robot can automatically define a new operation space, and perform the work task in the new operation space, without requiring human intervention.

Navigating using the localization system may include navigating using a UWB, RADAR, WLAN, Wi-Fi, Bluetooth, or Acoustic localization system, and/or navigating using a localization system comprising a mobile beacon disposed on the mobile robot in communication with the plurality of beacons. In the latter case, navigating using the localization system when transporting the first beacon to a second position for the beacon may include determining, by the mobile robot, the orientation of the mobile robot using the mobile beacon and the beacon which is being transported in communication with the remainder of the plurality of beacons. The second position may be along a line extending through the first beacon and a second beacon of the operation space, and the second position may be approximately equidistant from the second beacon as the first beacon. Said line may lie along an edge of the operation space. Interacting, by the mobile robot, with the first beacon may include engaging, by the mobile robot, an end effector of a manipulator of the mobile robot with the beacon.

In accordance with another aspect, also disclosed herein is a method for alignment recalibration of a mobile robot. The disclosed method includes a recalibration identifying step, a recalibration aligning step, a recalibration determining step, and a recalibration moving step. The recalibration identifying step involves identifying, by a processing unit, a movable reference object based on information from one or more sensors on the mobile robot. The recalibration aligning step involves aligning, by the processing unit, one or more axes of an orientation system based on at least one of a line defined by a face of the reference object or an angle of a corner of the reference object. In the recalibration determining step, the processing unit determines whether the reference object is to be moved to a new position based on at least a measure of if the reference object is at least partially obstructed. In the recalibration moving step, the mobile robot moves the reference object to the new position upon determination that the reference object is to be moved.

In the recalibration aligning step, aligning one or more axes of an orientation system may include calibrating an Inertial Measurement Unit (IMU). Identifying the movable reference object may involve detecting the reference object using one or more of an electromagnetic, optical, or acoustic sensor system. Identifying the movable reference object may involve detecting a movable beacon of a localization system of the mobile robot, and the localization system may be any one of an electromagnetic, optical, or acoustic localization system.

### BRIEF DESCRIPTION OF THE DRAWINGS

In the following, embodiments of the present disclosure will be described with reference to the appended drawings. However, various embodiments of the present disclosure are not limited to arrangements shown in the drawings.

FIG. 1A is a plan view of one embodiment of a mobile robot carrying out a method for transportation of a plurality of articles.

FIG. 1B is a perspective view of an exemplary mobile robot of FIG. 1A.

FIGS. 2A-2E are plan views of the embodiment of FIG. 1, showing details of the unloading and travelling steps.

FIG. 3A is a plan view of another embodiment of a mobile robot carrying out the method for transportation of a plurality of articles.

FIG. 3B is a perspective view of an example mobile robot of FIG. 3A.

FIGS. 4A and 4B are plan views of the embodiment of FIG. 3, showing details of the unloading step.

FIG. 5 is a block diagram view of an embodiment of a method for transportation of a plurality of articles.

FIG. 6 is a block diagram view of another embodiment of a method for transportation of a plurality of articles.

FIG. 7 is a plan view showing different drop-off configurations and patterns.

FIG. 8 is a plan view of another embodiment of a mobile robot carrying out a method of transportation of a plurality of articles.

FIG. 9 is a schematic view of an embodiment of a system implementing a method for expanding the operation space of a mobile robot.

FIGS. 10A and 10B are schematic views of an alternative embodiment of a system implementing a method for expanding the operation space of a mobile robot.

FIG. 11 is a perspective view of a localization beacon operable with the systems of FIGS. 9, 10A and 10B.

FIG. 12 is a block diagram illustrating a method for expanding the operation space of a robot.

FIG. 13 is a schematic view of a system showing a mobile robot determining its orientation while expanding the operation space.

FIG. 14 is a schematic view of an embodiment of a system for implementing a method for recalibration of a mobile robot, using a movable reference.

FIG. 15 is a block diagram of a method for alignment recalibration using a movable reference.

### DETAILED DESCRIPTION

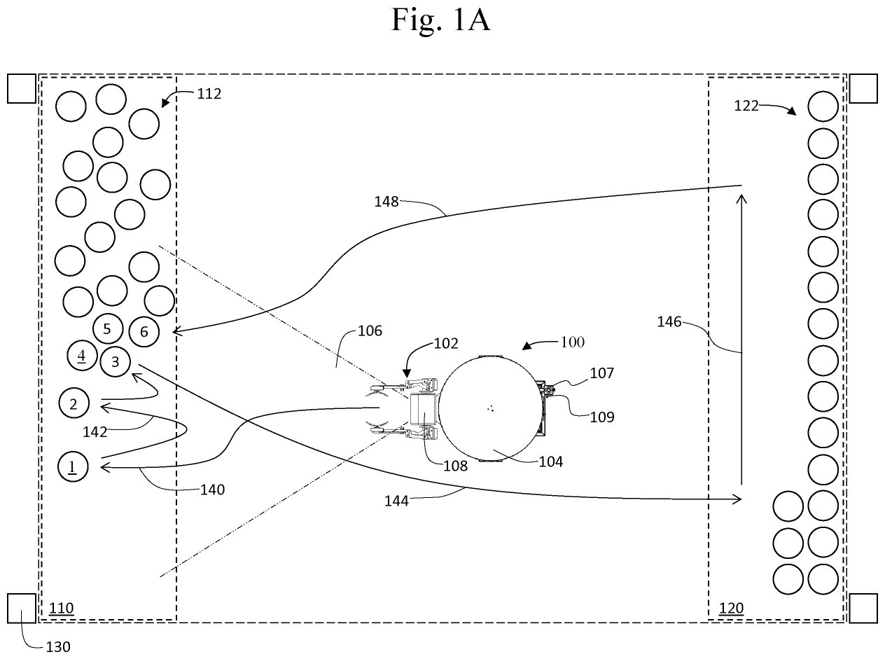

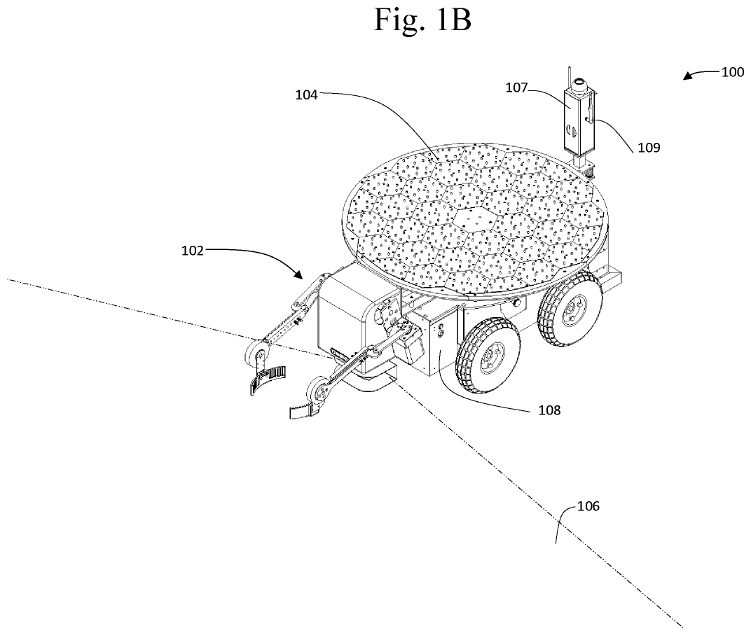

Referring to FIG. 1A, a plan view of an embodiment of a mobile robot 100 carrying out a method for transportation of a plurality of articles is shown. The mobile robot 100 includes a manipulator 102 and a transport surface 104. The mobile robot 100 additionally includes one or more sensors, which have a field of view 106 allowing the sensors to detect a plurality of articles 112 located at a pick-up area 110 which are to be transported. The mobile robot 100 may also include a processing unit 108 on board, or may be in communication with an external processing unit such as a local server or cloud server through communication device 109, the processing unit 108 comprising a memory and a processor capable of carrying out instructions stored in the memory.

The processing unit 108 may establish an absolute coordinate system by communicating, through the mobile robot 100, with one or more static reference points, such as beacons 130 using a positioning system. For example, an absolute coordinate system may be established by at least a UWB tag 107 disposed on the mobile robot 100 communicating with the fixed beacons 130 through UWB by measuring time of flight to determine the distance of the robot from the beacon. Two UWB tags 107 may be disposed on the robot 100 with a certain distance from each other to enable determining the orientation of the robot 100 in the absolute coordinate system. The processing unit 108 may correlate the information from the mobile robot's 100 one or more sensors, such as the detected articles in the field of view 106, with the established absolute coordinate system to generate a persistent map of the position of articles and store it in the memory. The map may be updated as the mobile robot 100 moves and rotates, seeing additional obstacles and articles such as deposited articles 122 at the drop-off area 120, or other articles 112 at the pick-up area 110.

The UWB beacons may provide the coordinates of the mobile robot 100 in 2 dimensions (x,y) or 3 dimensions (x,y,z). In case the field, where the mobile robot 100 is working in, has negligible changes in elevation, the coordinates of the robot 100 and the articles could be mapped in two dimensions by the processing unit 108. Otherwise (for example, if the field has a considerable slope or the field has steps and ramps), the processing unit 108 may create a three-dimensional map of the field using the UWB beacons and the sensors onboard the robot.

The robot 100 is configured to pick up a plurality of articles from a pick-up area 110, transport the articles to a destination, and drop them off at a drop-off site 120.

When the robot 100 is facing towards the pick-up area 110, the processing unit 108 selects a set of articles (labeled 1 through 5) out of the plurality of articles 112 at the pick-up area 110 according to a predetermined set of criteria and parameters. The criteria may include selecting a set of articles that their pick-up consume the least amount of time and energy from the robot 100. The criteria may use a cost function of weighted parameters such as distance to be moved, rotation required, and obstructions for each of the detected articles from the plurality of articles 112. The processing unit 108 may be configured to assign a cost value to each article in the plurality or articles 112 based on the cost function, for example and then may determine a sequence for picking up the selected set of articles. The processing unit 108 may do so by further considering the effect on the cost functions of each other article by selecting a given article to pick up, for example, and minimizing this cost in order to minimize movement needed to access and load each of the selected articles onto the transport surface 104.

The processing unit 108 then directs the mobile robot 100 to load the selected articles onto the transport surface 104. In this configuration, the robot 100 first approaches the first article from the set of selected articles (labeled 1 through 5) through a first planned route 140, then moves to pick up each individual article from the remainder of the selected articles through subsequent planned routes 142. In order to facilitate placing multiple articles to the transport surface 104, the transport surface 104 and the manipulator 102 may rotate with respect to each other so that the manipulator has access to different locations of the transport surface 104, such as by rotating the transport surface 104 with respect to the chassis of the robot 100 as a rotating table, or by rotating the manipulator 102 with respect to the chassis 100, for example. However, there may be other methods to facilitate placing multiple articles on the transport surface 104. For example, the transport surface 104 may have rollers and conveyor belts to facilitate locating and distributing the loaded articles on the transport surface 104 once an article is loaded to it using the manipulator 102, or the manipulator 102 may move on rails to access different levels of a multi-levelled transport surface 104, or any other method of accessing and storing a plurality of articles.

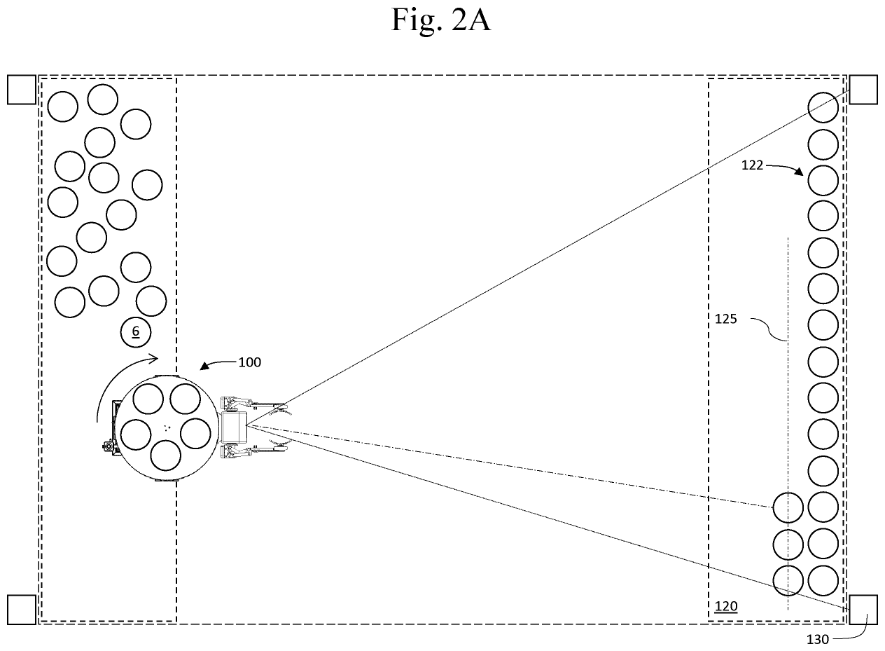

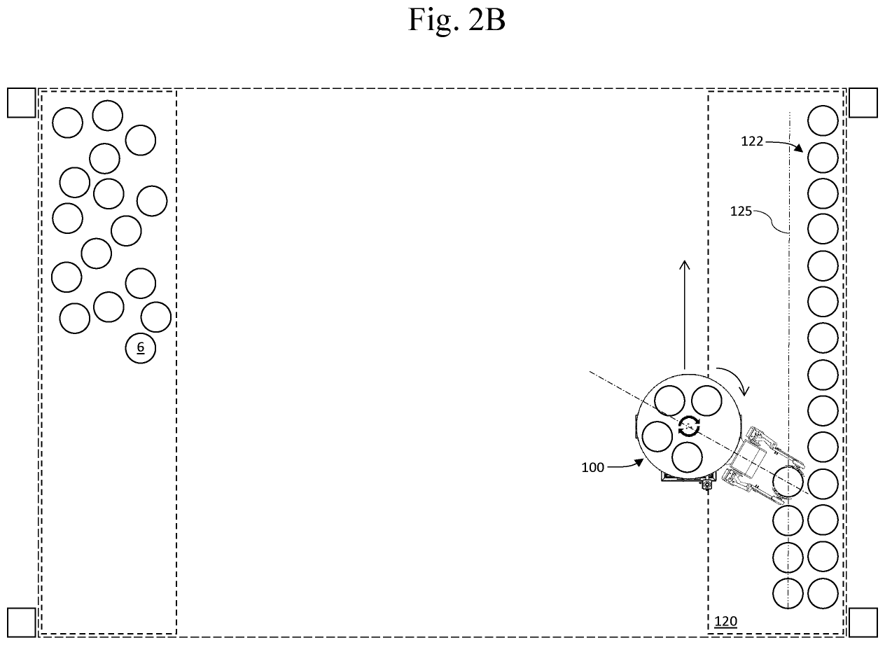

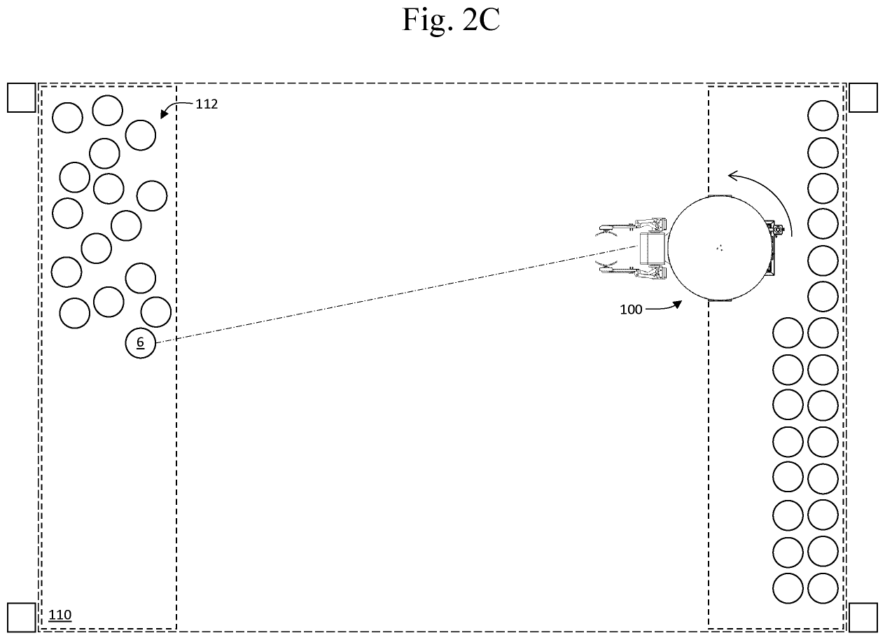

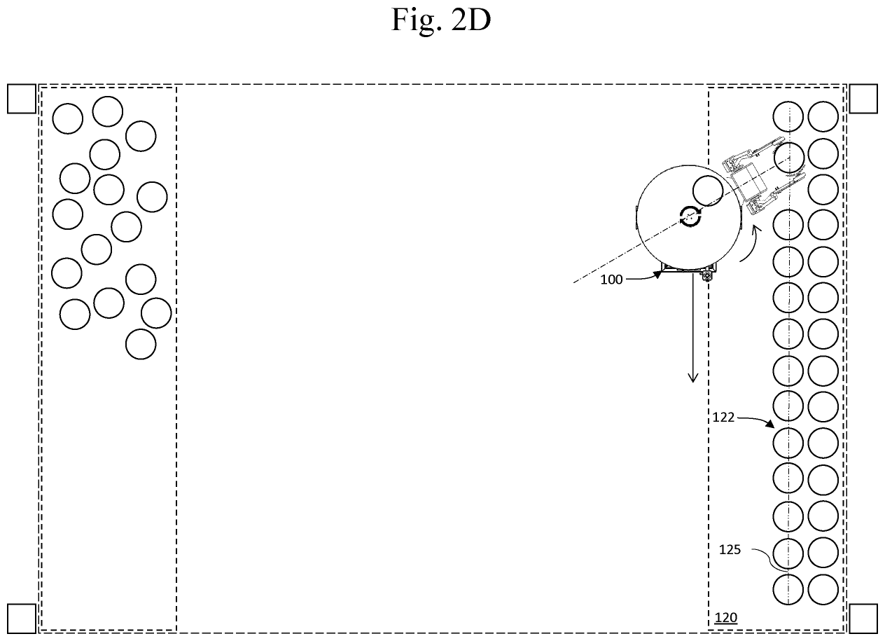

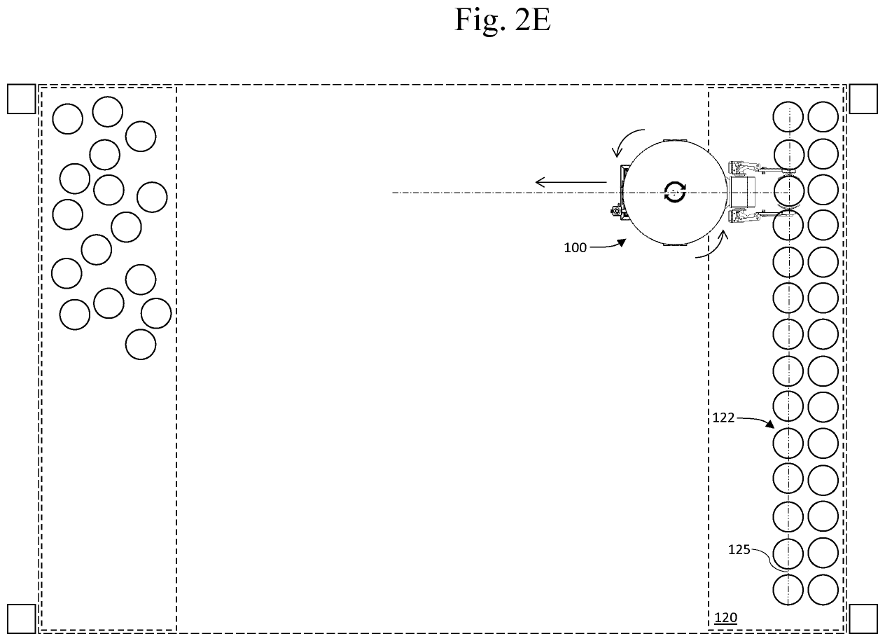

When each article of the set of articles has been loaded onto the transport surface 104, the mobile robot 100 travels along route 144 to the drop-off area 120 (details shown in FIG. 2A). When the robot 100 arrives at the drop-off area 120, the robot 100 unloads the articles along a path 146 (details shown in FIG. 2B). As shown, the loading and unloading of articles to and from the transport surface takes place sequentially (i.e. for loading, the next available position on the transport surface is used). However, it is possible to modify this order to provide for better load balancing during the loading and unloading steps. The robot 100 then travels 148 back to the pick-up area 110 (details shown in FIG. 2C) to pick up additional articles.

Referring to FIG. 1B, a perspective view of an exemplary embodiment of the robot 100 is shown. Although not expressly shown, it is contemplated that the transport surface 104 may optionally be provided with various posts, braces or dividers, or other such protrusions/indentations to help stabilize or secure the articles during transport (so that they do not “slip off” or become jostled away from their designated load positions). For the same reason, it is contemplated that the transport surface 104 may also be provided with a relatively rough top surface (which provides greater friction with the loaded articles).

Referring now to FIG. 2A, the mobile robot shown generally at 100 has now concluded approaching through first route 140 and then loading a plurality of articles 114 (articles labelled 1 through 5 in this embodiment) through subsequent routes 142 onto its transport surface 104, and is about to travel to the drop-off area 120. The mobile robot 100 may need to reorient itself for efficient travel, and it may use the map to avoid collision with articles 112 while doing so. The mobile robot 100 then determines a route 144 to travel to the drop-off area 120. The location 52 where the first article is to be dropped-off may be given to the processing unit 108 in absolute coordinate system or may be calculated by the processing unit 108 using a landmark detectable by robots sensors, for example, the last dropped-off article 51 or the beacons 130, and a set of given parameters such as the required horizontal and vertical distances 160 and 162 between the dropped-off articles. Determination of the drop-off location 52 could be done using the global map and once identified the location may be stored in the map so that the map may facilitate guiding the robot 100 to the location 52.

As the robot 100 is traveling towards the identified location 52, it may use the absolute coordinate system through communicating with beacons 130 for example (robot's communication with beacons 130 is shown by lines 150 in FIG. 2A), or may use a relative coordinate system through detecting a placed article 51 of the plurality of placed articles 122 or the beacon 130 using sensors such as a LiDAR for example, or any combination of absolute and relative coordinate systems. While doing so, the processing unit 108 may, through the mobile robot 100, determine a drop-off line 125, and may utilise the detected line 125 for navigation, alignment, calibration—such as calibration of an Inertial Measurement Unit (IMU), or any other purpose. The line 125 may be determined based on a pattern from the previously placed articles.

Referring to FIG. 2B, the mobile robot 100 is shown in the process of unloading articles along the route 146 from its transport surface 104 to the drop-off area 120. The mobile robot 100 does so by aligning itself generally parallel to the drop-off line 125, moving along the line, and placing articles along the line. In the depicted embodiment, the mobile robot 100 can rotate its manipulator 102 with respect to its direction of travel, and optimally unloads at an angle of about 120 degrees from its direction of travel, facing generally rearwards. This angle allows the manipulator 102 to place articles with a closer spacing without interfering with already-placed articles 122. The mobile robot 100 may use a number of different systems to maintain alignment such as optical sensors, alignment to the absolute coordinate system, internal sensors such as an Inertial Measurement Unit (IMU), or any other system or device. The robot 100 may adjust the placement position along the drop-off line 125 by moving the chassis of the robot forwards and backwards, and may adjust the position perpendicular to the drop-off line 125 (such as the distance between lines) by adjusting the angle of the manipulator 102 with respect to the chassis, for example. While in the depicted embodiment the placed articles 122 are in a rectilinear configuration (that is, each article is place in a rectilinear direction with respect to each other article), the articles may be placed in any other configuration such as a staggered or diamond configuration, or along curves where the drop-off line 125 is a curve, for example. The placement configuration may be predetermined or preprogrammed for the processing unit 108.

Referring now to FIG. 2C, the mobile robot 100 is shown having finished unloading articles from its transport surface 104 and is returning to the pick-up area 110 to repeat the process with additional articles 112. The processing unit 108 may have stored the position of an identified article (labelled 6) detected during the previous loading process and stored in the global map, for example. The processing unit 108 may use this identified article 6 as a reference point for navigation to the pick-up area 110. The mobile robot 100 may move towards the identified article 6, and use its sensors to detect additional articles for pick-up. Moving towards a remembered article offers advantages over utilizing the absolute coordinate system or relative coordinate system, as it directs the mobile robot 100 towards a position where an article 6 is already known to exist, eliminating the need to search for articles.

An optional variation of the drop-off method is shown in FIGS. 2D and 2E in cases which the robot 100 must remain within the bounds of the work area, in cases which the boundaries are defined by absolute barriers such as walls, rapid changes in elevation, or other barriers which preclude the robot 100 from accessing space outside the strict bounds of the work area. Normally, the robot 100 carries out the drop-off with the chassis leading the drop off position, as shown in FIG. 2B, for example. When the robot 100 approaches the end of line 125, the robot 100 would then have to partially exit the bounds of the work area to place the remaining articles if the drop-off sequence is simply repeated and extrapolated to the end of the line. In FIG. 2D, the robot 100 instead stops repeating the process in FIG. 2B when there are a predetermined number of articles left to be placed in the line, shown in this embodiment as 3 articles, but the amount can be any number of articles, which allows the robot 100 to remain within bounds at all times. When this number of articles remaining is reached, the manipulator 102 mirrors its position with respect to an axis perpendicular to the line of drop-off and the robot 100 instead starts drop-off in the opposite direction, mirroring the initial motion, for the first series of articles but in the opposite direction. The robot 100 may also rotate its chassis 180 degrees as well, or may simply reverse its motion. The robot 100 stops this drop-off sequence when there is one article remaining to be placed. This is done to prevent the manipulator 102 from colliding with placed articles 122 by angling the manipulator 102. However, for the final article, this method of drop-off cannot be continued since the last article placed in the initial method would present an obstruction. Instead, the robot 100 (or alternatively, the manipulator 102) aligns perpendicular to the drop-off line 125 and performs the final drop-off between the final articles placed by the methods of FIG. 2B and FIG. 2D respectively through placing the article directly in front of the robot 100, which may be done while the robot 100 is reversing, as shown in FIG. 2E, in a reverse manner to the sequence for pick-up, for example. This minimizes the chance of collision between the manipulator 102 and placed articles 122, as the robot's sensors would have both of the nearest placed articles 122 within its field of view 106 and the robot 100 can maneuver to place the final article in the proper position.

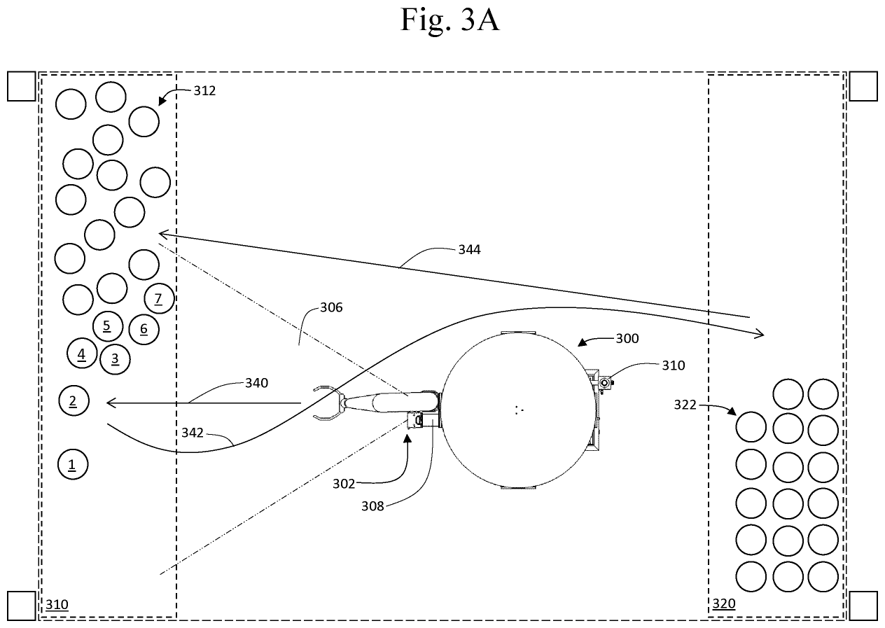

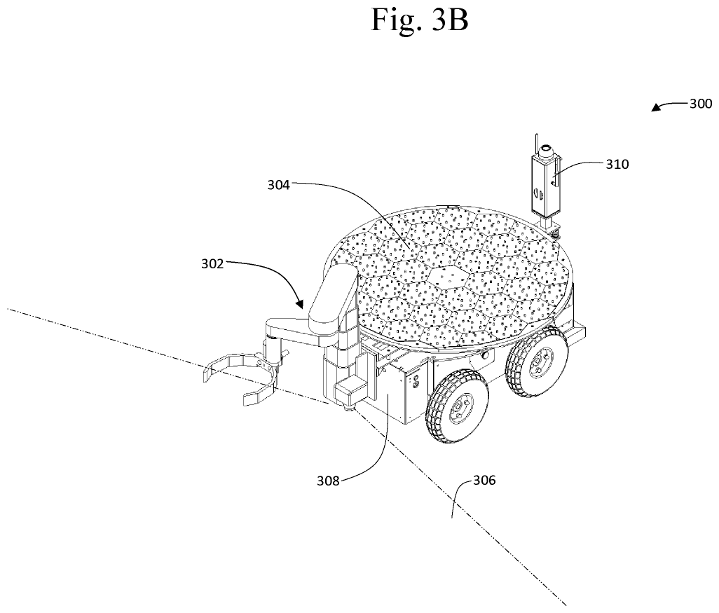

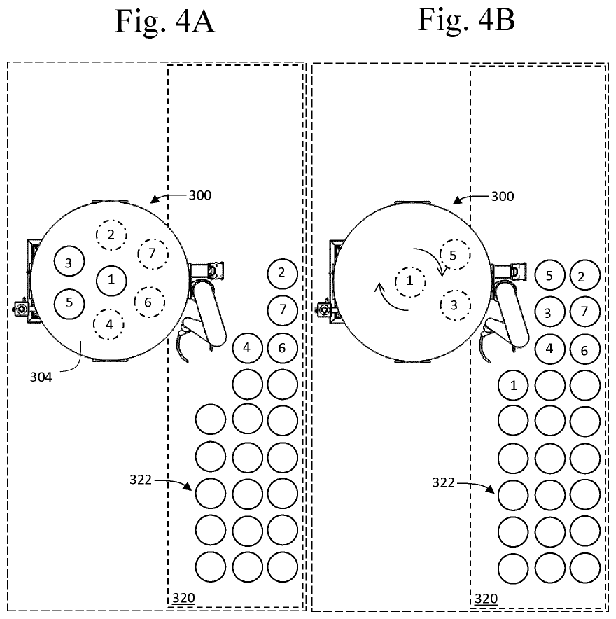

In FIG. 3A and FIGS. 4A-C, a plan view of another embodiment of a mobile robot 300 carrying out a method for transportation of a plurality of articles is shown. The plan view may include elements similar to those of FIGS. 1 and 2A-C, but within the respective 300 series of reference numbers, whether or not those elements are shown.

The mobile robot 300 of FIGS. 3A and 3B has an alternative manipulator 302, the manipulator 302 being a Selective Compliance Assembly Robot Arm (SCARA) manipulator. While a SCARA manipulator is depicted for this illustrative embodiment, aspects of this disclosure may apply to any choice of manipulator or end effector. For example, the processing unit 308 may direct the mobile robot 300 to follow a modified method for transportation of a plurality of articles according to the different capabilities and limitations imposed by the different manipulator. In this illustrative embodiment, the processing unit 308 directs the mobile robot 300 to identify, using one or more sensors, articles (labelled 1 through 7) of a plurality of articles 312 at a pick-up area 310 with in its field of view 306. The processing unit 308 may then identify an optimal position for the mobile robot 300 to approach 340, such that the manipulator 302 has maximum access to the identified articles 1 through 7. The SCARA manipulation 302 may allow the mobile robot 300 to load each of articles 1 through 7 onto the transport surface 304 without additional movement.

The mobile robot 300 then moves 342 to drop-off area 320 to place the loaded articles next to placed articles 322. In this illustrative embodiment, the method of filling the drop-off area 320 may be modified to facilitate the differing operational characteristics of the mobile robot 300 by placing the articles 322 in a cluster rather than rows, as the manipulator 302 allows for this pattern of placement while minimizing movement of the mobile robot 300. For other manipulator configurations on the mobile robot 300, other filling methods may be optimal and can be derived through a cost function analysis. The unloading step for this illustrative embodiment is shown in FIGS. 4A-C. After unloading, the mobile robot 300 returns 346 to the pick-up area 310 to load additional articles 312.

Referring to FIG. 3B, a perspective view of the mobile robot 300 is shown.

Referring to FIGS. 4A-B, the mobile robot 300 is unloading articles from its transport surface 304 to the drop-off area 320 next to placed articles 322. In this illustrative example, the processing unit 308 has selected a position for the mobile base which would minimize or eliminate the movement of the robot's base during drop-off. In FIG. 4A, the mobile robot 300 first unloads three articles 6,7, and 2 to the rearmost row, then one article 4 in the next row. As seen in FIG. 4B, in this example, the transport surface 304 is a rotating table, which may be rotated to facilitate ease of access by the manipulator 302 when unloading articles. In FIG. 4B, the mobile robot 300 unloads the final article placed at the center of the transport surface 304, filling the gap in the corner of the placed articles 322.

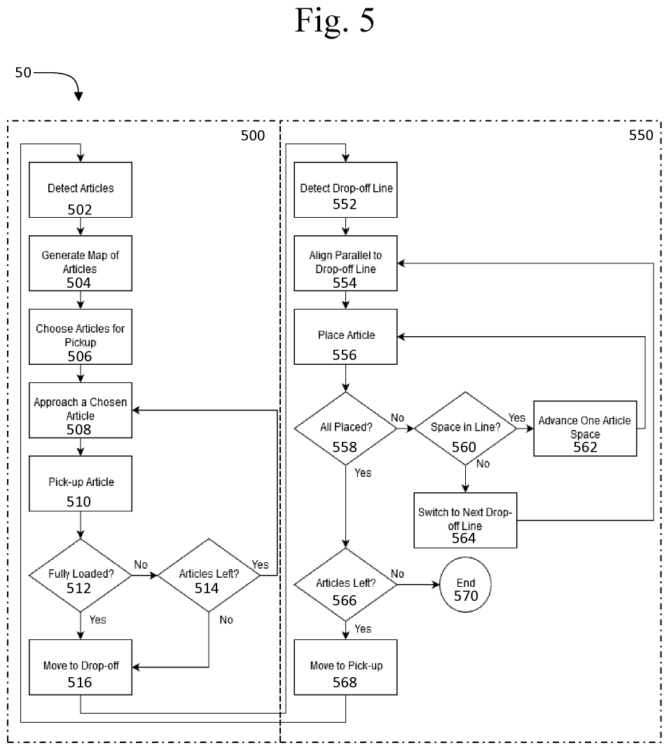

Referring to FIG. 5, an embodiment of a method for transportation of a plurality of articles is shown generally at 50. The method 50 generally consists of a loading process 500 and an unloading process 550. The loading process begins at a detecting step 502, where one or more sensors detect a plurality of articles to be transported at a predetermined pick-up area. A processing unit receives the signals from the sensors detecting the articles, and then generates a persistent map of the articles in mapping step 504. Generating the map may involve correlating the detected positions in a relative frame with an absolute coordinate system defined in the processing unit, using a localization system as a reference, for example. The detecting step 502 and mapping step 504 may continually be repeated in the background during the other steps of the method 50, where the processing unit continually updates the global map based on articles detected by the one or more sensors. The method 50 then proceeds to selecting step 506, wherein the processing unit chooses or selects a subset of the plurality of articles to load for transport. The selection may be based on predetermined parameters including minimizing a certain value such as energy cost due to movement, or time required, maximizing a certain value such as accessibility to articles to ease navigation, for example. The selection may be aided by information provided by one or more sensors or the global map.

After a subset of articles have been selected, the method 50 then proceeds to a loop of steps for preparing the selected articles for transport. In the approaching step 508, the processing unit sends a signal directing the transport unit, such as a mobile robot with a manipulator and a transport surface, to approach one of the selected articles. In the next step, the loading step 510, the processing unit directs the transport unit to load the article it has approached, such as engaging the article with the manipulator unit of the mobile robot, picking up the article, and placing it on the transport surface of the mobile robot, for example. The loading step 510 may also include additional steps including configuring of the transport surface to accommodate additional articles, such as rotating a rotating table, or rolling rollers to move recently-loaded articles to accommodate new articles being loaded, for example. During the approaching 508 and loading 510 steps, the processing unit may refer to the map generated in mapping step 504 to avoid collisions with articles it previously detected. The method 50 then proceeds to the first of two checks in the loading process 500. In the first check 512, the processing unit checks if the transport unit is fully loaded, such as counting the number of articles loaded and determining whether the transport surface can carry additional articles. If the transport unit is not fully loaded, the method 50 proceeds to the second check 514, whereas if it is fully loaded, the method 50 proceeds to moving step 516, exiting the loop. In the second check 514, the processing unit checks if there are additional articles remaining in the subset of articles selected in selecting step 506. If there are articles remaining, the method 50 loops back to approaching step 508 for the next article in the selected subset. If there are no articles remaining in the selected subset, then the method 50 proceeds to moving step 516, exiting the loop. In moving step 516, the processing unit directs the transport unit to move from the predetermined pick-up area to the predetermined drop-off area to unload the articles. During this step 516, the processing unit may refer to the map generated in mapping step 504 to avoid collisions with articles it previously detected.

The method 50 then proceeds to the unloading process 550, starting at detection step 552. In detection step 552, the one or more sensors detect a drop-off line located at the drop-off area. This may be done while the transport unit is in transit between the pick-up area and the drop-off area, where the sensors mounted on the unit may have an improved field of view, for example. Additional steps may occur during detection step 552, such as calibration of various sensors, localization onto an absolute coordinate system, and mapping of detected articles and features onto a persistent global map by the processing unit, for example. After detection step 552, the method 50 then enters a loop of steps for unloading the articles from transport. In the aligning step 554, the transport unit aligns itself along a placement line generally parallel to the drop-off line, such as the drop-off line detected in detection step 552, or another line which the processing unit determines such as a line parallel but spaced apart from the detected drop-off line if the detected drop-off line is fully occupied by articles, for example. The aligning step 554 may also involve aligning the manipulator, such as rotating the manipulator at an offset angle with respect to the direction of motion of the robot for more efficient unloading, for example. The method 50 then proceeds to placing step 556, wherein the processing unit directs the transport unit to place an article it has transported along the placement line. The transport unit may be directed to use its manipulator to move an article from its transport surface onto the placement line, for example. The processing unit then goes into a series of checks. In the first check 558, the processing unit determines if all the articles the transport unit transported from the pick-up area have been placed in the drop-off area, such as by keeping count, for example. If all transported articles have not been placed, the method 50 proceeds to second check 560, and if all transported articles have been placed, the method 50 then proceeds to third check 566. In the second check 560, the processing unit determines whether there is sufficient space in the placement line to accommodate further placement of articles. The processing unit may do this through the use of sensors detecting vacant spaces, by using the absolute coordinate system to determine the position of the transport unit, or by any other method. If there is sufficient space in the line, the processing unit directs the transport unit to advance one space in advancing step 562, and the method 50 then loops back to placement step 556. If the processing unit determines that there is insufficient space, the method 50 instead moves to line switching step 564 wherein the processing unit determines a new placement line and directs the transport unit to align with the new placement line by looping back to aligning step 554. In the third check 566, the processing unit checks if there are additional articles remaining at the pick-up area for further transporting to the drop-off area. The processing unit may do this by using the map generated in mapping step 504, or it may actively search for additional articles, for example. If the processing unit determines that there are additional articles to transport, the method 50 proceeds to moving step 568 wherein the processing unit directs the transport unit to move back to pick-up area to pick up more articles, and the method 50 returns to detecting step 502. If instead the processing unit determines there are no additional articles to transport, then the method 50 ends 570.

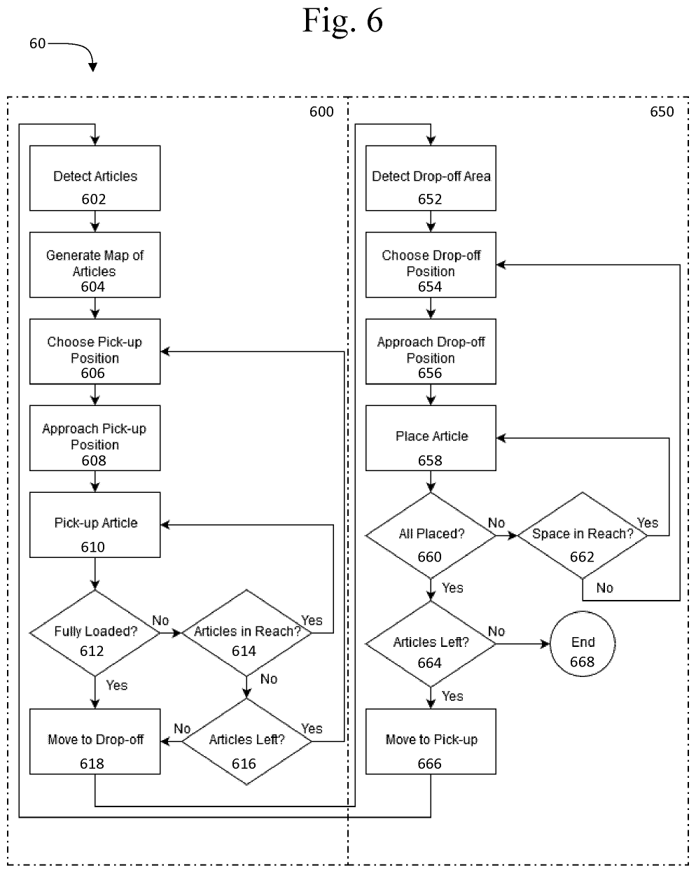

Referring to FIG. 6, another embodiment of a method for transportation of a plurality of articles is shown generally at 60. The method 60 generally consists of a loading process 600 and an unloading process 650. The loading process begins at a detecting step 602, where one or more sensors detect a plurality of articles to be transported at a predetermined pick-up area. A processing unit receives the signals from the sensors detecting the articles, and then generates a persistent map of the articles in mapping step 604. Generating the map may involve correlating the detected positions in a relative frame with an absolute coordinate system defined in the processing unit, using a localization system as a reference, for example. The detecting step 602 and mapping step 604 may continually be repeated in the background during the other steps of the method 60, where the processing unit continually updates the global map based on articles detected by the one or more sensors. The method 60 then proceeds to selecting step 606, wherein the processing unit chooses or selects a position for the transport unit to locate to being loading articles onto its transport surface. The selection may be based on predetermined parameters including minimizing a certain value such as energy cost due to movement, or time required to complete loading, maximizing a certain value such as accessibility to articles to ease navigation, for example. The selection may be aided by information provided by one or more sensors or the global map.

After a subset of articles have been selected, the method 60 then proceeds to a loop of steps for preparing the selected articles for transport. In the approaching step 608, the processing unit sends a signal directing the transport unit, such as a mobile robot with a manipulator and a transport surface, to the selected loading position. In the next step, the loading step 610, the processing unit directs the transport unit to load an article within reach of the loading position the transport unit has approached, such as engaging the article with the manipulator unit of the mobile robot, picking up the article, and placing it on the transport surface of the mobile robot, for example. The loading step 610 may also include additional steps including configuring of the transport surface to accommodate additional articles, such as rotating a rotating table, or rolling rollers to move recently-loaded articles to accommodate new articles being loaded, for example. During the approaching 608 and loading 610 steps, the processing unit may refer to the map generated in mapping step 604 to avoid collisions with articles it previously detected. The method 50 then proceeds to the first of three checks in the loading process 600. In the first check 612, the processing unit checks if the transport unit is fully loaded, such as counting the number of articles loaded and determining whether the transport surface can carry additional articles. If the transport unit is not fully loaded, the method 60 proceeds to the second check 614, whereas if it is fully loaded, the method 60 proceeds to moving step 618, exiting the loop. In the second check 614, the processing unit checks if there are additional articles remaining within reach of the manipulator from the loading position of the transport unit. If there are articles remaining, the method 60 loops back to loading step 610 for to load an additional article. If there are no articles remaining within reach, then the method 60 proceeds to the third check 616. In the third check, the processing unit determines whether or not there are further articles to be loaded for transporting to the drop-off area. If the processing unit determines that there are further articles, the method 60 loops back to selecting step 606 to select a new loading position to pick up the additional articles. If the processing unit determines that there are no other articles, the method 60 proceeds to moving step 618 exiting the loop. In moving step 618, the processing unit directs the transport unit to move from the predetermined pick-up area to the predetermined drop-off area to unload the articles. During this step 618, the processing unit may refer to the map generated in mapping step 604 to avoid collisions with articles it previously detected.

The method 60 then proceeds to the unloading process 650, starting at detection step 652. In detection step 652, the one or more sensors detect a drop-off area, which may be defined in terms of an absolute coordinate system, or through detection of articles already placed at or near the drop-of area, or through any other method of detection. This may be done while the transport unit is in transit between the pick-up area and the drop-off area, where the sensors mounted on the unit may have an improved field of view, for example. Additional steps may occur during detection step 652, such as calibration of various sensors, localization onto an absolute coordinate system, and mapping of detected articles and features onto a persistent global map by the processing unit, for example. After detection step 652, the method 60 then enters a loop of steps for unloading the articles from transport. In selection step 654, the processing unit selects a position within the detected drop-off area for unloading articles. This selection may be based on a number of factors including minimizing a certain value such as energy cost due to movement, or time required to complete loading, maximizing a certain value such as accessibility to articles to ease navigation, for example. The selection may be aided by information provided by one or more sensors or the global map. The method 60 then proceeds to approach step 656, where the processing unit directs the transport unit to approach the selected unloading position. The next step is the placing step 658, wherein the processing unit directs the transport unit to place an article it has transported while located at the unloading position. The transport unit may be directed to use its manipulator to move an article from its transport surface onto the drop-off area near the unloading position, for example. The processing unit then goes into a series of checks. In the first check 660, the processing unit determines if all the articles the transport unit transported from the pick-up area have been placed in the drop-off area, such as by keeping count, for example. If all transported articles have not been placed, the method 60 proceeds to second check 662, and if all transported articles have been placed, the method 60 then proceeds to third check 664. In the second check 662, the processing unit determines whether there is sufficient space within reach of the transport unit near the unloading position suitable to accommodate further placement of articles. The processing unit may do this through the use of sensors detecting vacant spaces, by using the absolute coordinate system to determine the position of the transport unit, or by any other method, and it may do so taking into account the placement pattern desired for articles at the drop-off area. If there is sufficient space, the method 60 then loops back to placement step 658. If the processing unit determines that there is insufficient space, the method 60 instead loops back to selection step 654 wherein the processing unit determines a new unloading position. In the third check 664, the processing unit checks if there are additional articles remaining at the pick-up area for further transporting to the drop-off area. The processing unit may do this by using the map generated in mapping step 604, or it may actively search for additional articles, for example. If the processing unit determines that there are additional articles to transport, the method 60 proceeds to moving step 666 wherein the processing unit directs the transport unit to move back to pick-up area to pick up more articles, and the method 60 returns to detecting step 602. If instead the processing unit determines there are no additional articles to transport, then the method 60 ends 668.

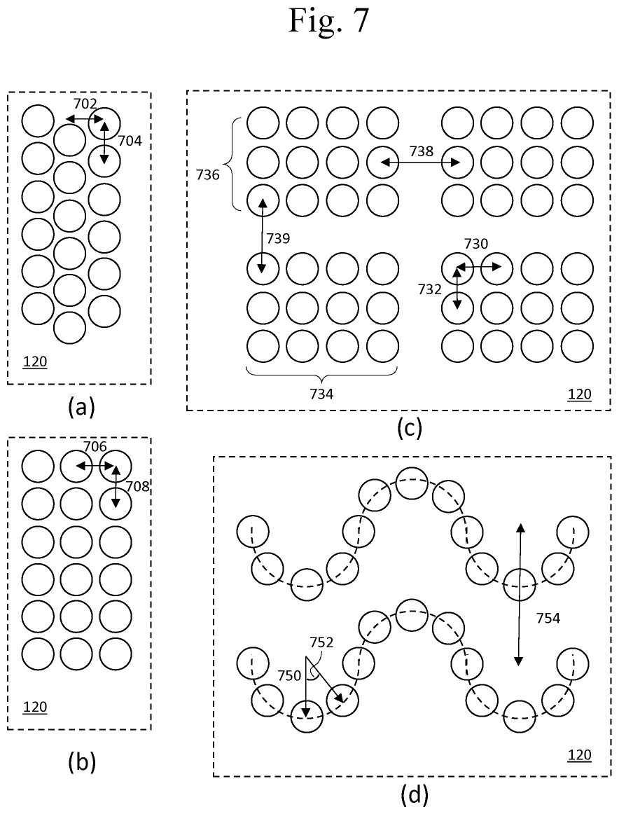

Referring to FIG. 7, plan views of embodiments of various drop-off configurations in drop-off area 120 are shown in sections (a) to (d). Each drop-off configuration could be achieved by the robot by introducing the pattern and parameters associated with the pattern. For example, section (a) shows a hexagonal pattern with parameters 702 and 704 representing the horizontal and vertical distance between the dropped-off articles. Section (b) shows a square pattern with parameters 706 and 708 representing the horizontal and vertical distance between the dropped-off articles. Section (c) shows a clustered pattern with parameters 730 and 732 representing the horizontal and vertical distance between the dropped-off articles in each cluster, parameters 734 and 736 representing the number of articles in generally a horizontal and vertical alignment in each cluster, and parameters 738 and 739 representing the distance between clusters in generally horizontal and vertical directions. Section (d) shows a curved pattern with parameters 750, 753 and 754 representing the radius of the curve, the angle between two consecutive articles and distance between two consecutive rows of the curvature.

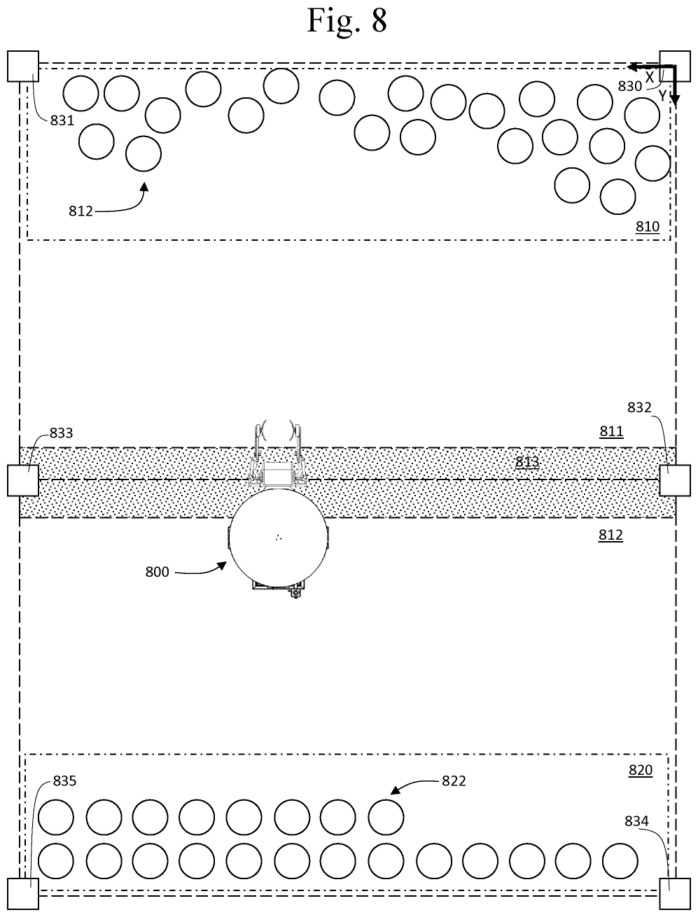

Referring to FIG. 8, a plan view of an embodiment of a mobile robot 800 carrying out a method for transportation of a plurality of articles is shown. The mobile robot 800 may be substantially similar to the mobile robot 100 of FIG. 1, for example. The field in this embodiment is similar to, but comparatively larger compared to the field in FIG. 1, such that pick-up area 810 may be a sufficient distance away from drop-off area 820 such that UWB communications between the robot 800 and pick-up beacons 830,831 near the pick-up area 810 may be insufficiently accurate due to distance effects when the robot is near drop-off area 820, or vice versa with communications between the robot 800 and drop-off beacons 834,835 near the drop-off area 820 when the robot is near the pick-up area 810, for example. In such a case, the field may include intermediary sets of beacons 832,833 placed between the pick-up area 810 and the drop-off area 820, dividing the field into two or more cells, such as pick-up cell 811 and drop-off cell 812. In other embodiments there may be additional sets of intermediary beacons defining multiple intermediary cells. When robot 800 is in the pick-up cell 811, the robot 800 is in effective and accurate communication range with the pick-up beacons 830,831 and the intermediary beacons 832,833, and can use these four beacons for UWB navigation. When the robot is in the drop-off cell 812, the robot 800 is instead in effective communication range with the intermediary beacons 832.833 and the drop-off beacons 834,835, again being able to use these four beacons for UWB navigation. By placing additional sets of intermediary beacons 832,833, the distance between the pick-up area 810 and the drop-off area 820 can be any distance, so as long as sufficient intermediary beacons 832,833 are placed such that at least four beacons are in effective range of the robot 800 at any given time. Additionally, there may be a buffer zone 813 around each set of intermediary beacons 832 and 833 which is in effective range of both sets of beacons flanking the intermediary beacon 832 and 833—in this case, the pick-up beacons 830 and 831 and the drop-off beacons 834 and 835. While operating in the buffer zone 813, the robot 800 continues to use the four beacons in use before entering the buffer zone 813. Upon exiting the buffer zone 813, the robot 800 then determines which cell, such as pick-up cell 811 or drop-off cell 812, and uses the four beacons corresponding to that cell. The buffer zone 813 thereby prevents rapid or repeated switching between sets of beacons selected by the robot 800 to use when the robot 800 is near intermediary beacons 832 and 833.

The position of each beacon 830 to 835 is determined in an arbitrary global or relative coordinate system. This determination could be done manually by measuring the position of the beacons in the coordinate system or automatically using a predetermined protocol and using the UWB distance signals communicated between the beacons. For example, the protocol could be that the far most beacon in the pick-up area, beacon 830, is set to the origin of the coordinate system, the imaginary line connecting beacon 830 to the other beacon in the pick-up area, beacon 831, defines the positive X direction, the right-hand rule is used to determine the Y axis of the coordinate system, and then the location for all other beacons 831 to 835 are determined in this coordinate system based on the UWB signals communicated among the beacons 830 to 835. In case a 3D location determination is required, the protocol could further include identifying a Z axis which starts at the origin and is extended normal to a plane that passes through beacons 830 to 832.

Given the location of the beacons 830 to 835 are determined in the coordinate system, as the robot is moving from pick up cell 811 to drop-off cell 812, at some point the measured location of the robot using the beacons 830 to 833 will identify that the robot is in the drop-off cell 812 and then beacons 832 to 835 will be used to localize the robot 800. The buffer area could be determined based on a predetermined distance around the intermediary beacons 832,834. For example, the buffer area may be defined by lines 40 cm into the pick-up and drop-off cells 811 and 812.

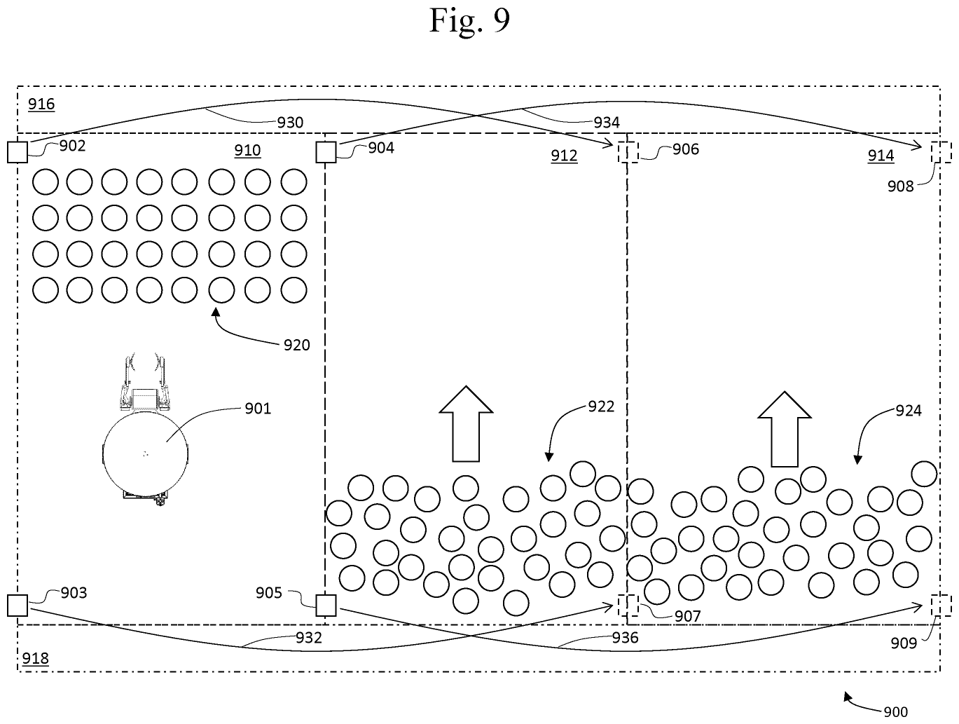

Referring to FIG. 9, a system 900 is shown for implementing a method for expanding the operation space of a mobile robot 901, which is used for the transportation of multiple articles. The system 900 includes a mobile robot 901 and four beacons 902, 903, 904, and 905, which define an operation space 910 within which the robot 901 may carry out tasks, using the beacons 902-905 for localization during carrying out the tasks. Beacons 902-905 communicate with the mobile robot 901 to allow the position of the mobile robot 901 to be determined through electromagnetic waves such as UWB, RADAR, WLAN, Wi-Fi or Bluetooth, for example, or may use other forms of transmission such as acoustic pressure waves. In the embodiment shown, the task may be moving articles 920 such as potted plants from one side of operation space 910 (such as near beacons 903 and 905) to the opposite side (such as near beacons 902 and 904), for example. In this embodiment, operation space 910 may be a single bay in a plant nursery, and there may be other bays adjacent to the operation space 910 such as additional bays 912 and 914. The bays 910, 912 and 914 may all be aligned and flanked by access pathways 916 and 918, which are generally kept free of obstacles. Additional bays 912 and 914 may each have corresponding sets of articles 922 and 924 such as pots which are to be moved to the opposite end of their respective bays and arranged in an orderly fashion. In this scenario, once the robot 901 has completed the initial task of moving and arranging articles 920 in the operation space 910, the robot is now idle.

Usually, an external agent such as a human operator must then manually move beacons 902-905 to new positions around a new operation space such as bay 912, and manually move the robot to bay 912, as the robot cannot function outside of operation space 910 due to being out of range of the localization system provided by beacons 902-905. However, in the disclosed embodiment, the robot 901 recognizes that it has completed all available tasks assigned to it within operation space 910, and additionally has tasks in additional bays 912 and 914 assigned to it. Upon completion of the tasks in operation space 910, the mobile robot 901 then begins the process of moving the operation space 910 from its initial bay to bay 912. To move the operation space 910, the robot 901 moves beacon 902 to a first new position 906, and beacon 903 to a second new position 907. New positions 906 and 907 are on the opposite side of, and substantially equally distant to, beacons 904 and 905 compared to initial positions of beacons 902 and 903. Ideally, the beacons 902 and 903 are moved one at a time, with the remaining three beacons acting to localize robot 901. By moving beacons 902 and 903 across the positions of beacons 904 and 905, the mobile robot 901 can move within a space where it remains within range of the localization system provided by the remaining 3 beacons. For example, when the robot 901 is moving beacon 902, it first moves from operation space 910 into the adjacent bay 912, but staying relatively near beacons 904 and 905 such that beacon 903 remains in range. The robot 901 then moves into access pathway 916 and moves to pick up beacon 902. The robot 901 then moves beacon 902 to new position 906 following path 930. However, when the robot 901 is moving along path 930, it may reach a point where beacon 903 is out of effective range. The robot 901 can still carry out navigation based on the two remaining beacons 904 and 905. For example, while the robot 901 may be out of effective range of beacon 903, it may still be in functional range of beacon 903. In such a case, the robot 901 may be receiving distance information from beacon 903, but the distance information may be relatively inaccurate. The robot 901 remains within effective range of beacons 904 and 905 at all times and receives accurate distance information from these two beacons, thus, through triangulation or trilateration, the robot 901 can at least narrow down its position to one of two possible points with accuracy. The robot 901 may further use the inaccurate information from beacon 903 coupled with historical data to determine which of the two possible points it is located in, for example. When beacon 902 is placed in new position 906, the robot 901 may then navigate back to pick up beacon 903, using beacons 902 (at 906), 904 and 905 when the robot 901 is in bay 912, and beacons 903, 904 and 905 when it is in space 910. When beacon 903 is picked up, the robot 901 again uses the accurate information from beacons 904 and 905 coupled with inaccurate data from beacon 902 (at 906) and/or historical data to navigate along path 932 until robot 901 is within effective range of beacon 902, and places beacon 903 at new position 907. The operation space 910 is now redefined as bay 912, and the robot 901 can then carry out the task of moving and arranging articles 922 in bay 912 using the beacons 904, 905, 902 (at 906), and 903 (at 907) for localization.

When the robot 901 has completed all tasks in the operation space 910 (now 912), it can repeat the process, this time moving beacons 904 and 905 to new positions 908 and 909 along paths 934 and 936 respectively, redefining the operation space 910 as bay 914 in order to allow the robot 901 to move and arrange articles 924. In this manner, the robot 901 can effect horizontal operation space expansion as the robot 901 can continuously move into adjacent operation spaces to continue operation.

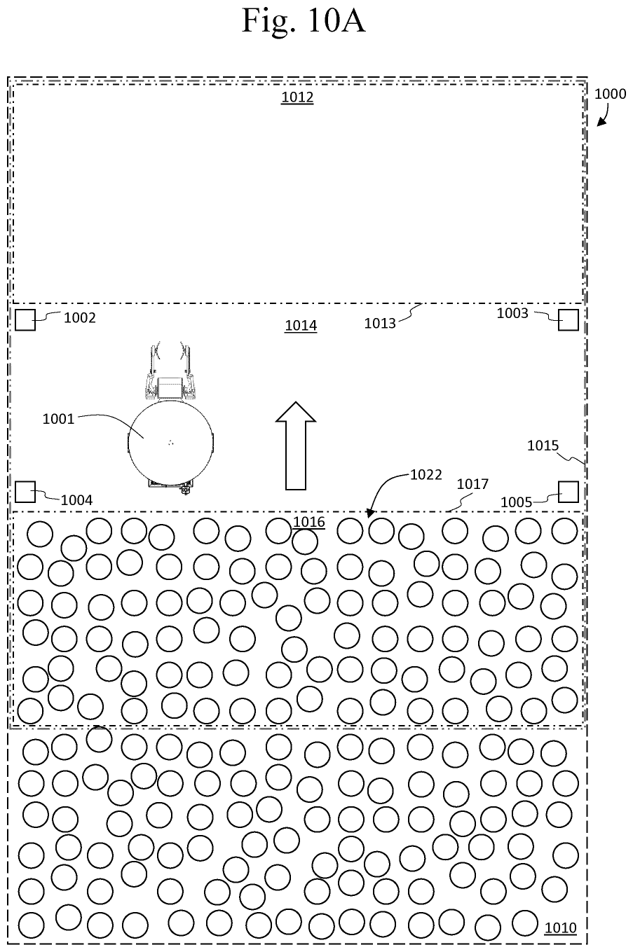

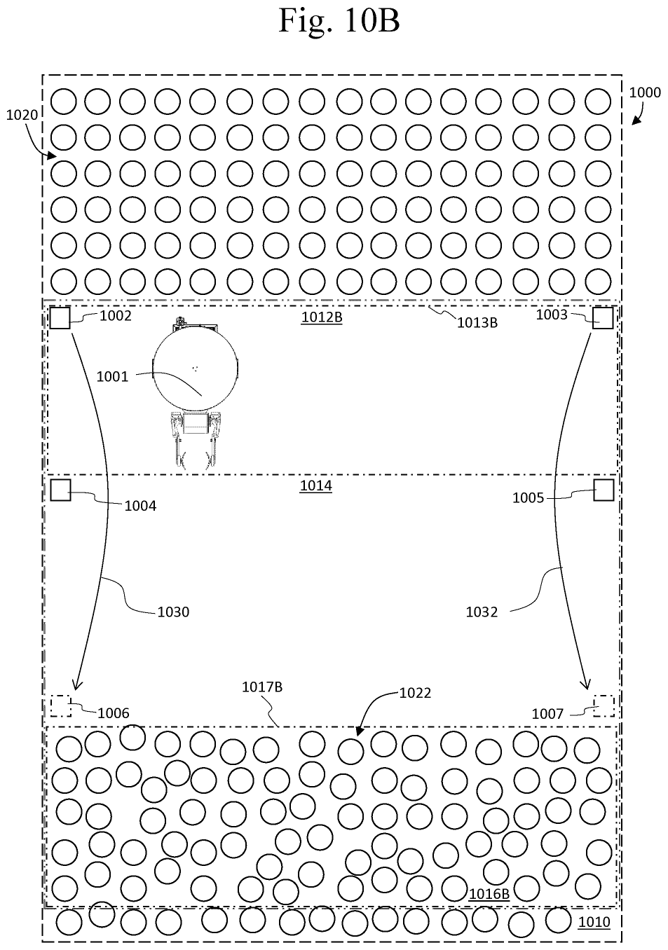

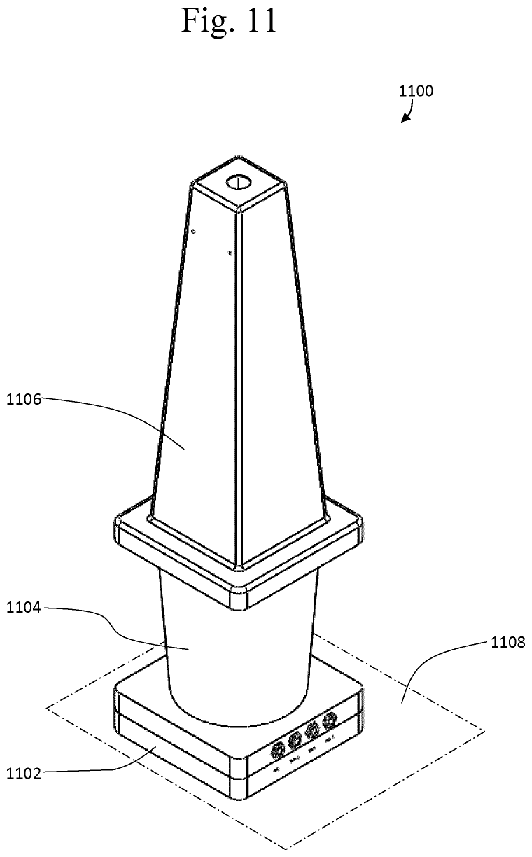

Referring to FIGS. 10A and 10B, an alternative system implementing a different method for expanding the operation space of a robot is shown generally at 1000. The system 1000 includes a mobile robot 1001 and four beacons 1002, 1003, 1004, and 1005 located within a field 1010. The robot 1001 and beacons 1002-1005 are similar to the beacons 92-95 of FIG. 9.

As seen in FIG. 10A, the effective range of beacons 1002-1005 define an operation space 1014, defined by border line 1015, which can be further divided into a drop-off area 1012, defined by border line 1013, and a pick-up area 1016, defined by border line 1017, on either side of the beacons 1002-1005. In this embodiment, the robot 1001 is tasked with moving a plurality of articles 1022, such as potted plants, from the pick-up area 1016 to the drop-off area 1012. There may be more articles 1022 than accessible with the pick-up area 1016 as currently defined as certain articles may be further from beacons 1002-1005 than the effective range of the beacons 1002-1005, for example. In such a case, it may be desirable for the robot 1001 to autonomously expand the operation space 1014 such that additional articles 1022 may be accessed, so that the robot 1001 may complete its task of moving articles 1022 entirely autonomously without the need for an external party such as a human operator to monitor and/or assist the robot 1001 in redefining its operation space 1014, for example.

Referring now to FIG. 10B, the robot 1001 has completed its initial task of moving and arranging articles 1020 placed into what was drop-off area 1012 of FIG. 10A, and what was pick-up area 1016 of FIG. 10A is now vacant. In order to access further articles 1022, the robot 1001 now proceeds to expand the operation space 1014 vertically, within the same field 1010. The robot 1001 first approaches beacon 1002, and then transports it along path 1030 to a new position 1006. During the entirety of this process, the robot 1001 remains within the effective range of the remaining beacons 1003, 1004 and 1005. Once beacon 1002 is placed at 1006, the robot 1001 then repeats the process except with beacon 1003, transporting it along path 232 to a new position 207. During the entirety of this process, the robot 201 remains within the effective range of the remaining beacons 1002 (now at 1006), 1004 and 1005. With the beacons 1002-1005 now located at 1004, 1005, 1006, and 1007, the robot 1001 has now redefined the operation space 1014. The region which was previously empty between the beacons 1002, 1003 and beacons 1004, 1005 in FIG. 10A is now defined as new drop-off area 1012B by border line 1013B. The region beyond beacons 1002, 1003 at new positions 1006, 1007 but still in range of all four beacons 1002-1005 is now defined as new pick-up area 1016B by border line 1017B. The robot can now repeat the task of moving and arranging articles 1022 from new pick-up area 1016B to new drop-off area 1012B, placing them next to the previously-placed articles 1020.

The field 1010 may continue to extend for any length, and the robot 1001, by following this method, will be able to eventually access and move all articles 1022 in field 1010. For example, as seen in FIG. 10B, there is a single row of articles 1022 not included in new pick-up area 1012B. If the robot 1001 needs to also move these articles 1022, the robot 1001 may repeat the above procedure, instead moving beacons 1004, 1005 to new positions adjacent to the last row, thereby again redefining new pick-up and drop-off areas, for example. If there are even more articles 1022, the robot 1001 may continuously repeat this process, by alternatively moving beacon sets 1002, 1003 and 1004, 1005 in a staggered manner to continuously redefine and effectively expand the operation space 1014 of the mobile robot 1001 to accommodate a vertically-extending field 1010 of any length.

Furthermore, the vertical operation space expansion of FIGS. 10A and 10B may be coupled with the horizontal operation space expansion of FIG. 9 if the adjacent fields follow a specific configuration. If adjacent fields or bays are arranged in alternating fashion with articles clustered at alternating opposite ends, the robot can expand the operation space vertically along a first field according to the system shown in FIGS. 10A and 10B, then expand the operation space horizontally into an adjacent field according to the system shown in FIG. 9 once it has reached the end, then expand the operation space vertically in the opposite direction for the second field, expanding horizontally again, and repeating to cover a field arrangement of any size.

Referring to FIG. 11, an embodiment of a robot-movable beacon is shown generally at 1100. The beacon 1100 comprises a base panel 1102, a robot-interaction region 1104, and a cone region 1106. The base panel 1102 may include various ports such as power and signal interfaces for charging or configuring the beacon. The base panel 1102 may also include indicator lights for displaying the status of the beacon. The base panel 1102 generally has a different cross section from the articles in the operation space along a plane 1108, such that if the robot uses a detection method along the plane, such as a 2D LiDAR, the robot can easily differentiate the beacon 1100 from articles. The robot-interaction region 1104 has a substantially similar shape to the articles, such that the robot can easily interact with the beacon 1100 using the same end effector used to interact with articles—in the disclosed embodiment, the articles may be cylindrical pots, and the beacon 1100 has a cylindrical robot-interaction region 1104 of similar dimensions to the pots (articles), such that the robot can easily interact with and transport the beacon 1100. The cone region 1106 extends above the robot-interaction region 1104 and may house communication devices such as antennae or transceivers for communicating with the robot. The additional height provided by the cone region 1106 may provide clearance over the articles and assist in providing an unobstructed line of sight between any communication devices and the robot while the robot is in operation. The cone region 1106 may also provide other functionality, such as assist human operators in identifying the operation space, for example.

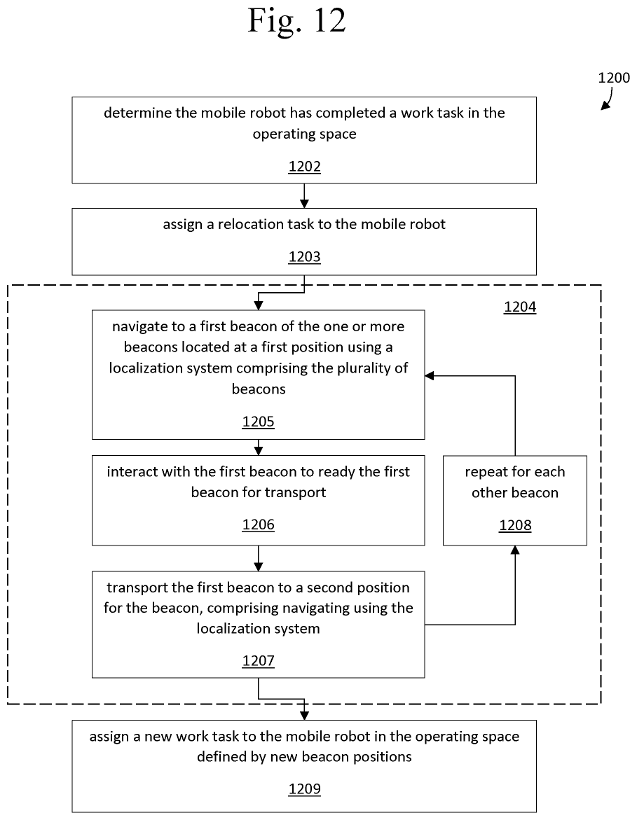

Referring to FIG. 12, a method for expanding the operation space of a robot is shown generally at 1200. The method includes a determining step 1202, an assigning step 1203, and executing step 1204 and a second assigning step 1209. In the determining step 1202, a processing unit determines that the mobile robot has completed a work task in a current operation space. The work task may be the last task assigned to the robot such that there are no further tasks to do in the operation space, and the robot may become idle without additional tasks assigned. In the assigning step 1203, the processing unit assigns a relocation task to the mobile robot. In the executing step 1204, the mobile robot executes the relocation task, the relocation task including a navigating step 1205, and interacting step 1206, a transporting step 1207, and a repeating step 1208. The executing step 1204 begins with the navigating step 1205, which involves the mobile robot navigating to a first beacon of the one or more beacons located at a first position using a localization system comprising the plurality of beacons. The executing step 1204 then proceeds to the interacting step 1206 where the mobile robot interacts with the first beacon to ready the first beacon for transport, such as engaging the first beacon with the end effector of a manipulator on the mobile robot, for example. The executing step 1204 then involves transporting the first beacon to a second position for the beacon by the mobile robot, including navigating the mobile robot using the localization system, in the transporting step 1207. If there are still other beacons in the one or more beacons to be moved, the executing step 1204 then proceeds to the repeating step 1208, which involves repeating the steps of the executing step 1204 starting from the navigating step 1205 for each other beacon of the one or more beacons to be moved. If all the beacons have been moved, the method 1200 instead proceeds to the assigning step 1209, where the processing unit assigns a new work task to the mobile robot in the operation space defined by new beacon positions.

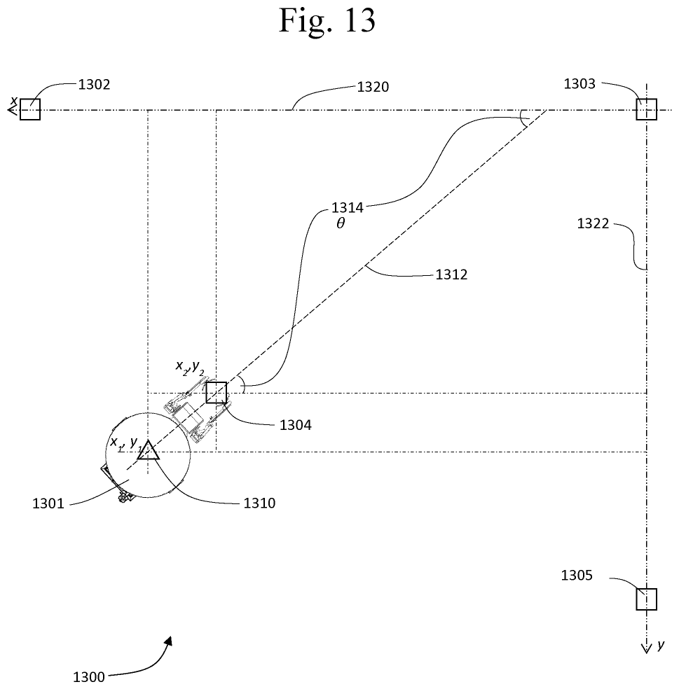

Referring to FIG. 13, a system implementing an alternative method for expanding the operation space of a robot is shown generally at 1300. The system 1300 includes a mobile robot 1301 and four beacons 1302, 1303, 1304, and 1305. The beacon 1304 is in the process of being transported by robot 1301 to expand the operation space. The remaining beacons 1302, 1303, and 1305 define a coordinate system for localization, having a horizontal (x) axis 1320 and a vertical (y) axis 1322. The mobile robot 1301 comprises a mobile beacon 1310 integral to the mobile robot 1301, which communicates with beacons 1302, 1303, and 1305 to determine its position in terms of the axes as (x₁, y₁). Similarly, beacon 1304 also communicates with beacons 1302, 1303, and 1305 to determine its position in terms of the axes as (x₂, y₂). The orientation of the robot 1301 can be determined by determining the direction of the line of heading 1312, specifically the angle θ 1314 that the line makes with the x axis, which can be determined according to the relationship:

$$θ = {tan}^{- 1} \frac{{y}_{1} - {y}_{2}}{{x}_{1} - {x}_{2}}$$

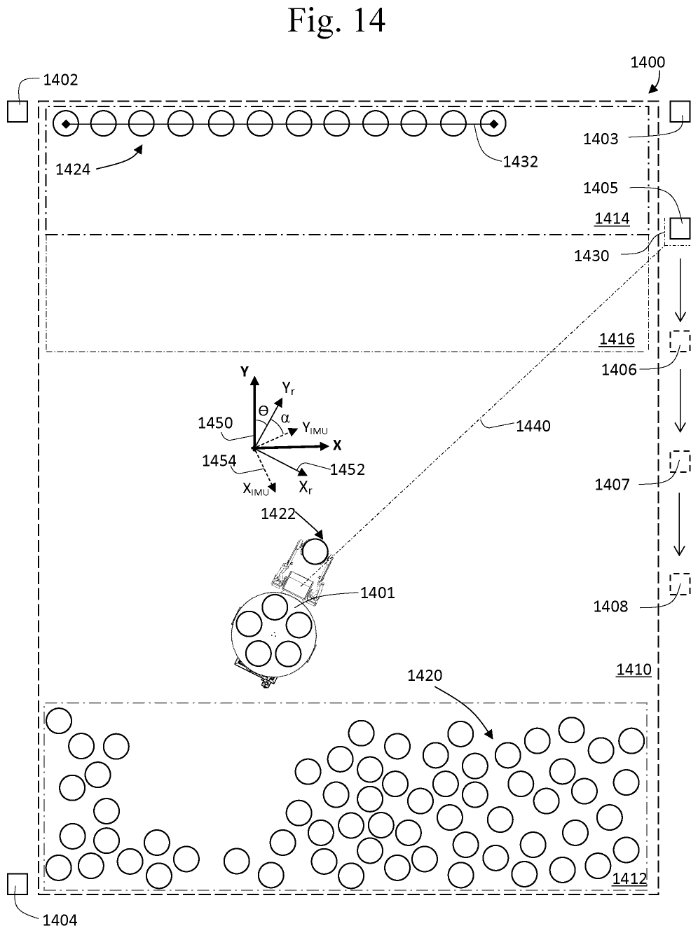

Referring to FIG. 14, a system for implementing a method for alignment recalibration is shown generally at 1400. The system 1400 includes a mobile robot 1401 operating within an operation space 1410. In this embodiment, the robot 1401 is carrying out tasks such as moving articles 1420 from a pick-up area 1412 to a drop-off area 1414; the robot 1401 may be carrying a plurality of articles 1422 and placing the articles in the drop-off area 1414 in an orderly and spaced arrangement 1424. When carrying out the tasks, the robot 1401 uses a localization system including a plurality of beacons placed around the operation space 1410, including beacons 1402, 1403, and 1404, and reference beacon 1405. A sensor (not shown) on the robot 1401, such as an electromagnetic transceiver, LiDAR, and vision camera is used to interact with the beacons 1402, 1403, 1404, and 1405 to determine the position of the robot in the operation space 1410.

As previously described, the localization system may determine the position of robot 1401 through interaction of electromagnetic waves such as UWB, RADAR, WLAN, Wi-Fi or Bluetooth for example, or may use other forms of transmission such as acoustic pressure waves. The waves may be sent from the transceiver on the robot 1401, or one or more of the beacons 1402, 1403, 1404 and/or 1405. In other possible embodiments, the localization system may determine the position of the robot 1401 by a LiDAR, vision camera or IR sensor on the robot. The sensor may measure the position of at least a subset of beacons 1402 to 1405 with respect to the mobile robot 1401 and then use the measurements to calculate the position of the robot 1401 in the operation space 1410.

Reference beacon 1405 may be substantially similar to localization beacons 1402, 1403, and 1404 and may additionally act as a fourth localization beacon to provide redundancy in the event of one of the beacons 1402, 1403, or 1404 failing, or to provide additional accuracy in localization, for example. The robot 1401 may additionally use additional sensors such as IR/Visible light cameras to assist in navigation and avoid collision with obstacles, for example, and may use internal devices such as an Inertial Measurement Unit (IMU), accelerometers, gyroscopes, odometers, or any other device to assist in navigation.

In the depicted embodiment, mobile robot 1401 is in the process of carrying articles 1422 from pick-up area 1412 to drop-off area 1414. The mobile robot 1401 does so using a combination of UWB localization using communication between an on-board transceiver and beacons 1402, 1403, 1404, and 1405 and LiDAR to determine its position. The robot 1401 additionally uses an IMU to determine its orientation θ, which is defined by the angle between the workspace coordinate system XY 1450 and the robot's coordinate system XᵣYᵣ 1452. However, in reality, IMUs usually experience drift over time, especially when the robot cycles through the operation space 1410 for several times, and needs to be recalibrated. For example, after a number of cycles, the IMU signals may give measurements that define the robot's coordinate system as the X_{IMU}Y_{IMU} coordinate system 154 which is drifted by a from the actual robot's coordinate system 1452. In order to fix the drift issue, the robot 1401 may detect reference beacon 1405 using a LiDAR detection ray for example, shown at 1440. The robot 1401 may specifically detect a distinguishing feature 1430 of reference beacon 1405, such as a characteristic face or angle of a corner, for example. The robot 1401 can use the distinguishing feature 1430 of the reference beacon 1405 as an orientation reference and recalibrate the IMU signals to overcome IMU drift, given the orientation of the distinguishing feature 1430 is known. The orientation of the distinguishing feature 1430 could be a prior knowledge, could be determined based on the IMU and LiDAR measurements at a time when the IMU has not yet drifted, or could be determined based on a sensor on the robot, such as LiDAR, and another reference with a known orientation such as a line of dropped off articles 1432.

In order to calibrate or recalibrate the on-board IMU, the orientation of the distinguishing feature 1430 is measured using the LiDAR (which is usually reliable, sufficiently accurate, and does not experience drift), and then calculating the orientation of the robot by using the measured orientation of the feature 1430 with respect to the robot and knowing the orientation of the feature 1430 with respect to the operation space 1410, and then compensating for the IMU drift using the calculated orientation of the robot. As the feature 1430 does not change between cycles of the robot 1401 moving articles from the pick-up area 1412 to the drop-off area 1414 and vice-versa, the orientation reference from the distinguishing feature 1430 could be considered a reliable reference to recalibrate the IMU. In other embodiments, a vision camera could be used instead of the LiDAR or in combination with the LiDAR to measure an orientation reference from the distinguishing feature 1430.

Eventually, however, as the collection of articles 1424 deposited at the drop-off area 1414 increases, the visibility of reference beacon 1405 may be decreased due to obstruction of line-of-sight for LiDAR, for example. When this occurs, the robot 1401 may have increasing difficulty identifying the feature 1430 of the reference beacon 1405. In such a case, the mobile robot 1401 moves to reference beacon 1405 and transports it to a new position 1406. During this process, the robot 1401 may use the last deposited row of articles 1424 as a reference, drawing a reference line 1432. The reference line 1432 is based directly on the previous detection of feature 1430, can be used to calibrate the positioning of the feature 1430 on reference beacon 1405 at new position 1406 for consistency. After the reference beacon 1405 has been placed at new location 1406, the robot 1401 can continue with its article transportation task using the reference beacon 1405 at 1406 to recalibrate the IMU while placing articles 1424 in new drop-off area 1416, until the position 1406 also begins to be obstructed, in which case the robot 1401 then moves it to second additional position 1407, continuing to work, moving the beacon to 1408 when position 1407 is occluded, and so on.

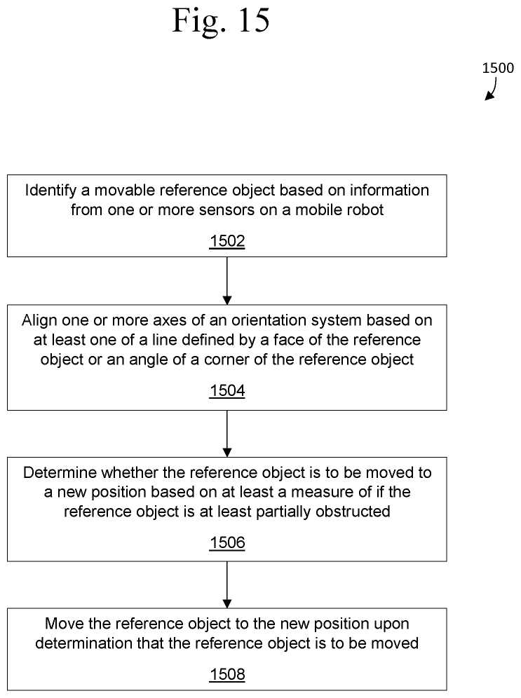

Referring to FIG. 15, a method for alignment recalibration using a movable reference is shown generally at 1500. The method includes a recalibration identifying step 1502, a recalibration aligning step 1504, and a recalibration determining step 1506, followed by a recalibration moving step 1508. Beginning with the recalibration identifying step 1502, a processing unit such as the central processing unit of a local or cloud server or an onboard computer of the autonomous mobile robotic vehicle for example, attempts to identify a movable reference object. The processing unit receives information one or more sensors on the mobile robotic vehicle and determines, using an algorithm or machine learning for example, the presence or absence of particular distinguishing features of the movable reference object in the information to identify the object. After identifying the object in the recalibration identifying step 1502, the processing unit then proceeds to the recalibration aligning step 1504 wherein the processing unit transforms one or more axes of an orientation system to align with the identified movable reference object, based on a distinguishing feature of the reference object such as a line defined by a face of the reference object, or an angle of a corner of the reference object. Upon completion of the recalibration aligning step 1504, the processing unit proceeds to the recalibration determining step 1506 which involves the processing unit making a determination on whether the reference object is to be moved to a new position based on an algorithm. The algorithm may instruct the processing unit to consider a measure of if the reference object is at least partially obstructed, or determine if the reference object is likely to be at least partially obstructed in terms of field of view in the subsequent cycle. If it is the case that the reference object is at least partially obstructed or is likely to be partially obstructed in a subsequent cycle, the method may then proceed to the recalibration moving step 1508. In the recalibration moving step 1508, the processing unit directs the mobile robot to move the reference object to the new position upon determination that the reference object is to be moved.

It is contemplated that the various disclosed methods for expanding the operation space of a mobile robot or methods for alignment recalibration may also be incorporated with the various methods/systems for transportation of a plurality of articles using a mobile robot as previously disclosed.

While specific embodiments have been described and illustrated, such embodiments should be considered illustrative of the invention only and not as limiting the invention as construed in accordance with the accompanying claims.

1. A method for transportation of articles using a mobile robot, the mobile robot comprising a mobile base, a manipulator which rotates with respect to the mobile base, a storage platform disposed on the base and one or more sensors, and the mobile robot provided with a navigation system, the method comprising:
detecting, by the one or more sensors, in a detecting step, a detected plurality of articles to be transported at a predetermined pick-up area;
mapping, by a processing unit, in a mapping step, the detected plurality of articles onto a global map based on an absolute coordinate system and storing the global map in a memory;
selecting, by the processing unit, in a selecting step, a selected set of articles out of the detected plurality of articles according to predetermined parameters;
determining, by the processing unit, in a first determining step, a determined sequence for picking up the selected set of articles;
loading, by the manipulator, in a loading step, the selected set of articles onto the mobile robot according to the determined sequence;
travelling, by the mobile robot, in a first travelling step, from the pick-up area to a predetermined drop-off area according to the navigation system;
determining, by the processing unit, in a second determining step, a target position within the drop-off area;
orienting the mobile base, in an orienting step, in a direction which does not require the base to be re-oriented for unloading at least two consecutive articles of the selected set of articles;
unloading, by the manipulator, in an unloading step, the selected set of articles to the target position according to predetermined settings;
travelling, by the mobile robot, in a second travelling step, from the drop-off area to the pick-up area; and
repeating from the detecting step until all articles are transported.

2. The method of claim 1, wherein the processing unit includes a local server or cloud server, disposed external to the mobile robot.

3. The method of claim 1, wherein the selecting step comprises determining, by the processing unit, a best article to select according to the predetermined parameters.

4. The method of claim 3, wherein the predetermined parameters includes one or both of distance from an object, and obstacles detected near the object.

5. The method of claim 3, wherein the selecting step further comprises determining, by the processing unit, a ranking of the detected plurality of articles according to the predetermined parameters.

6. The method of claim 5, wherein the first determining step comprises following the ranking of the detected plurality articles.

7. The method of claim 1, wherein the second determining step is based on one or more of:
a relative position of the mobile robot with respect to an object detected by the one or more sensors; or
an absolute position based on the absolute coordinate localization system.

8. The method of claim 1, wherein the predetermined settings include one or more of a drop-off pattern, drop-off spacing, physical dimensions of the drop-off area, physical dimensions of the articles, or physical dimensions of a defined operating area.

9. The method of claim 8, wherein the unloading step further comprises:
calculating, by the processing unit, the number of articles which may be placed in a row at the drop-off area based on the predetermined settings;
orienting the mobile robot substantially parallel to the row;
unloading articles into the row; and
switching to a new row when the maximum number of articles in a row is detected.

10. The method of claim 9, wherein the unloading step further comprises:
moving, by the mobile robot, in a direction substantially parallel to the row to control spacing between articles of the same row; and
adjusting, by the mobile robot, the angular orientation of a manipulator with respect to the heading of the mobile robot to control spacing of articles between different rows.

11. The method of claim 8, wherein the unloading step further comprises:
determining, by the processing unit, in a determining step, an optimal unloading position and orientation, and a number of articles to be unloaded based on information from the one or more sensors;
moving, by the mobile robot, to achieve the optimal unloading position and orientation;
unloading articles around the optimal unloading position according to a predetermined pattern; and
repeating from the determining step when the number of articles has been unloaded.

12. The method of claim 8, wherein the unloading step further comprises:
determining, by the processing unit, in a determining step, an optimal unloading position and orientation for the mobile robot and a number of articles to be unloaded, based on the predetermined settings;
moving, by the mobile robot, to achieve the optimal unloading position and orientation;
unloading articles around the optimal unloading position and orientation; and d. repeating from the determining step when the number of articles to be unloaded has been unloaded.

13. The method of claim 12, wherein the predetermined settings includes physical dimensions of a defined operating area, and wherein in the determining step, the optimal unloading position and orientation for the mobile robot is determined so as to avoid the mobile robot going outside of the defined operating area.

14. The method of claim 1, further comprising avoiding, by the mobile robot, articles mapped in the global map during one or more of the loading step, the first travelling step, the second travelling step, and the unloading step.

15. The method of claim 1, wherein the one or both of the first and second determining steps is based at least in part on the global map generated in the mapping step.

16. The method of claim 1, wherein the pick-up area is associated with a first operation space, the method further comprising:
determining, by the processing unit, that the mobile robot has completed a work task in the first operation space;
relocating the first operation space for the mobile robot to a second operation space, the first operating space defined by a first position of a plurality of beacons;
assigning, by the processing unit, a relocation task to the mobile robot, the relocation task comprising moving one or more beacons of the plurality of beacons from a first position of each of the one of more beacons to a second position of each of the one or more beacons, the second operating space defined by a second position of the plurality of beacons;
executing, by the mobile robot, the relocation task comprising:
navigating, by the mobile robot, to a first beacon of the one or more beacons located at a first position using a localization system comprising the plurality of beacons;
interacting, by the mobile robot, with the first beacon to ready the first beacon for transport;
transporting, by the mobile robot, the first beacon to a second position for the beacon, comprising navigating using the localization system; and
repeating from the navigating step for each other of the one or more beacons to be moved; and
assigning, by the processing unit, a new work task to the mobile robot in the second operation space.

17.-24. (canceled)
